(19) United States
(12) Patent Application Publication
(10) Pub. No.: US 2015/0051975 A1
(43) Pub. Date: Feb. 19, 2015

(54) GEOLOCATION CONVERSIONS BASED ON PRODUCT OR SERVICE AVAILABILITY

(71) Applicant: Google Inc., (US)

(72) Inventors: Mohammed Waleed Kadous, Santa Clara, CA (US); Russell Heywood, Santa Clara, CA (US); Cedric Dupont, San Francisco, CA (US); Isaac Richard Taylor, Mountain View, CA (US)

(73) Assignee: Google Inc., Mountain View, CA (US)

(21) Appl. No.: 13/734,518

(22) Filed: Jan. 4, 2013

(51) Int. Cl. G06Q 30/02

(52) U.S. Cl. CPC G06Q 30/0261
USPC 705/14.58

(57) ABSTRACT

Aspects of the present disclosure relate generally to using position information to provide advertisements. More specifically, wireless network access point data may be used to identify the position of a mobile device in an indoor space, which, in turn, may be used to identify products within the vicinity of the identified position. Based on the identified products, a server may send advertisements of the same or related products available at other locations to the mobile device.

### BACKGROUND

Modern mobile devices are equipped with location-based features. Content systems, such as advertisement systems, have used positioning technologies to provide location-based information and advertising to the mobile devices. For instance, some systems have used GPS technologies to locate a mobile device and provide location specific information to the mobile user such as airline and traffic information. Other systems have utilized GPS technologies to locate a mobile device and provide local advertisements to the user.

However, systems as such depend heavily on the strength of GPS satellite signals to detect location of the mobile device. In locations where the GPS satellite signals are weak or not detected, e.g., when the mobile devices are indoors, these systems may not function properly.

Furthermore, even if the systems provide location-based information or location-based advertisements to the mobile device, that information may not be interesting to the user, unless the systems specifically solicit or inquire about the user's areas of interest beforehand. However, a user may be reluctant to answer inquiries. Even if the user chooses to answer the inquiries, the same user's interests may change from time to time. For instance, the same user may develop interests in items that are different from his/her typical areas of interest, making it difficult for the systems to stay updated with the user's interests.

### SUMMARY

Aspects of the disclosure pertain to a system that could locate the mobile device without heavily relying on the GPS technologies. Another aspect provides a system that automatically identifies the user's interests, e.g., products or services that the user is interested in as of the moment, without specifically soliciting that information from the user.

One aspect of the disclosure provides a method for providing an advertisement on a wireless device. The method may include receiving a message broadcast by a wireless access point. The method may also include determining a signal strength of the message.

The method may further include using a processor to identify a wireless access point map associated with an indoor space. The map may define a plurality of positions. At least one position may be associated with a plurality of signal strengths of messages broadcast by different wireless access points. Further, at least one position defined on the map may be associated with a product.

A position of the wireless device may be identified on the map using the signal strength of the message. Further, a product placed within a predetermined distance of the wireless device may be identified based on the map. Information about the product may be sent to a server. The server may send an advertisement related to the product to the wireless device for presentation.

Another aspect of the disclosure provides an apparatus for providing an advertisement. The apparatus may include a receiver configured to receive a message broadcast by a wireless access point. The apparatus may also include a memory, and a processor in communication with the memory. The processor may determine a signal strength of the message received by the receiver.

In one aspect, the processor may identify a wireless access point map associated with an indoor space. The map may define a plurality of positions. At least one position defined on the map may be associated with a plurality of signal strengths of messages broadcast by different wireless access points. Further, at least one position defined on the map may be associated with a product.

A position of the apparatus may be identified on the map using the signal strength of the message. A product placed within a predetermined distance of the apparatus may be identified using the map. Information about the product may be sent to a server. The server may send an advertisement related to the product to the apparatus for presentation.

Yet another aspect of the disclosure provides a method for providing an advertisement. The method may include receiving, from a wireless device, a signal strength of a message broadcast by a wireless access point.

In one aspect, the method may include using a processor to identify a wireless access point map associated with an indoor space. The map may include a plurality of positions. At least one position defined on the map may be associated with a plurality of signal strengths of messages broadcast by different wireless access points. Further, at least one position defined on the map may be associated with a product.

A position of the wireless device may be identified on the map based on the signal strength. A product positioned within a predetermined distance of the wireless device may be identified based on the map. An advertisement related to the product may be transmitted to the wireless device.

A further aspect of the disclosure provides a system for providing an advertisement. The system may include a memory and a processor in communication with the memory.

A wireless access device may determine a signal strength of a message broadcast by a wireless access point. The wireless access device may send the signal strength to the processor.

The processor may identify a wireless access point map associated with an indoor space. The map may include a plurality of positions. At least one position defined on the map may be associated with a plurality of signal strengths of messages broadcast by different wireless access points. At least one position defined on the map may be associated with a product.

The processor may identify a position of the wireless device on the map based on the received signal strength. Further, the processor may identify a product positioned within a predetermined distance of the wireless device using the map. An advertisement related to the product may be transmitted to the wireless device.

### BRIEF DESCRIPTION OF THE DRAWINGS

The accompanying drawings, which are incorporated in and constitute a part of this specification, illustrate embodiments of the present disclosure and, together with the detailed description of the embodiments given below, serve to explain the principles of the disclosure.

FIG. 1 is a block diagram of a network that delivers information between a server and a client device in accordance with aspects of the disclosure.

FIG. 2 is a block diagram of components of the server and client device of FIG. 1 in accordance with one embodiment.

FIG. 3 is a map of an indoor space in accordance with one embodiment.

FIG. 4 is a map of the indoor space of FIG. 3 in accordance with another embodiment.

FIG. 5 is a flow diagram of a process by a client device for identifying a wireless access point map associated with the indoor space in accordance with an embodiment.

FIG. 6 is a flow diagram of a process by the client device for receiving advertisements based on position information in accordance with an embodiment.

FIG. 7 is a flow diagram of a process of FIG. 6 in accordance with another embodiment.

FIG. 8 is a flow diagram of a process of FIG. 6 in accordance with a different embodiment.

FIG. 9 is a table of inventory data stored in the server in accordance with an embodiment.

FIG. 10 is a flow diagram of a process by the server for identifying a wireless access point map associated with the indoor space in accordance with an embodiment.

FIG. 11 is a flow diagram of a process by the server for determining advertisements based on position information in accordance with one embodiment.

FIG. 12 is a flow diagram of a process of FIG. 11 in accordance with another embodiment.

FIG. 13 is a flow diagram of a process of FIG. 11 in accordance with a different embodiment.

FIG. 14 is an example of a graphical user interface displaying advertisements on the client device in accordance with an embodiment.

### DETAILED DESCRIPTION

For simplicity and clarity of illustration, like reference numerals may be used in the drawings to identify identical or analogous structural elements.

In situations in which a system, apparatus, method, device, part, or component described herein collects personal information about a user, such as a user location, or may make use of personal information, such as providing advertisements based on the user location, the user may be provided with an opportunity to control whether programs or features collect user information, or to control whether and/or how to receive content, such as advertisements, from a content server that may be more relevant to the user. In addition, certain data may be treated in one or more ways before it is stored or used, so that personally identifiable information is removed. For example, a user's identity may be treated so that no personally identifiable information can be determined for the user. Thus, the user may have control over how information is collected about the user and used by a content server.

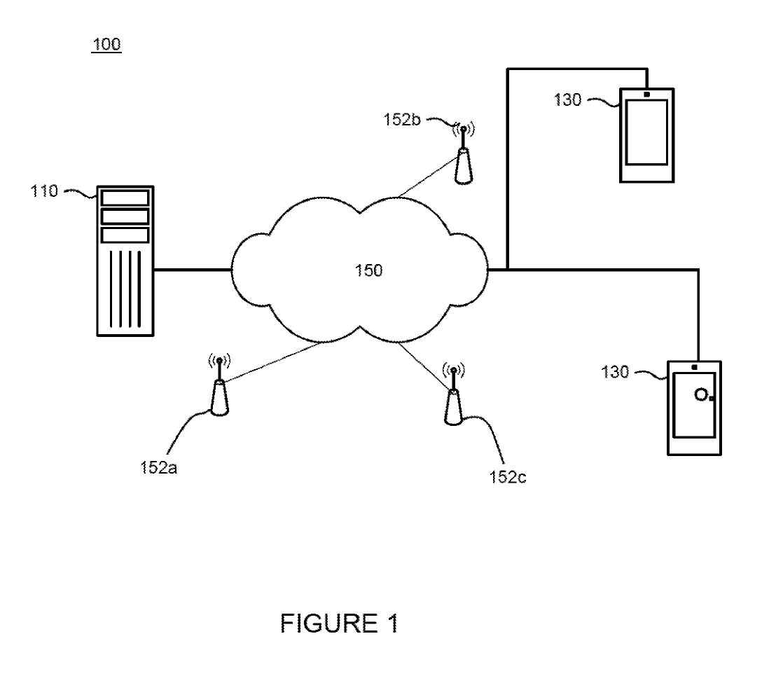

FIG. 1 illustrates a system 100 in accordance with one embodiment. The system 100 may include a server 110, one or more client devices 130, and a network 150. The network 150 may facilitate direct or indirect communication between the server 110 and the client devices 130. Although FIG. 1 illustrates only one server 110 in the system 100, more than one server 110 may be included in the system 110, and the servers 110 may work independently from or collaboratively with each other.

The network 150 may be, e.g., a wireless network, such as the Global System for Mobile Communications/General Packet Radio service (GSM/GPRS), Code Division Multiple Access (CDMA), Enhanced Data Rates for Global Evolution (EDGE), Universal Mobile Telecommunications System (UMTS), or a broadband network such as Bluetooth and Wi-Fi (the brand name for products using IEEE 802.11 standards). The network 150 may be identified by a Service Set Identifier (SSID), which is the key to access the network 150 by a wireless device. Each computer or device, e.g., the server 110 or the client device 130, on the network 150 may be a node. Each node on the network 150 may be uniquely identified by a Media Access Control address (MAC address).

The network 150 may include one or more wireless access points (WAPs) 152, e.g., 152a, 152b, or 152c, that may allow wireless devices, e.g., the client devices 130, to connect to the network 150 using Bluetooth, Wi-Fi, or other standards. A WAP may periodically broadcast information to wireless devices using a special 802.11 management frame known as a beacon frame. The beacon frame may include information that assists wireless devices to access the network 150, including the SSID of the network 150, the MAC address of the WAP 152, authentication mechanisms, and other relevant information.

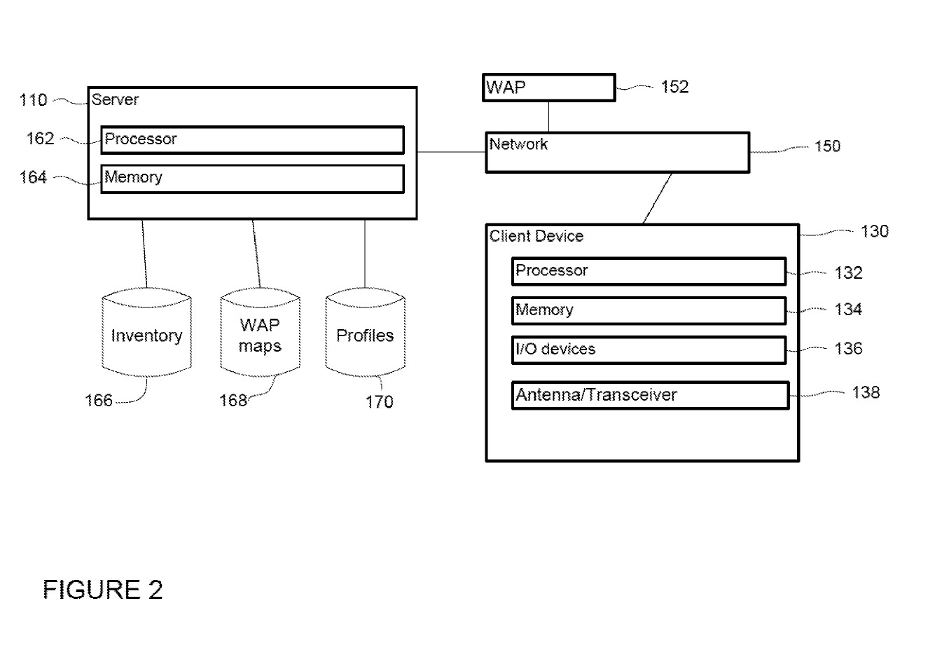

FIG. 2 illustrates one embodiment of the client device 130 and the server 110, respectively. As shown in FIG. 2, the client device 130 may include a processor 132, a memory 134, and I/O devices 136. The client device 130 may be a full-sized personal computer, or a mobile device capable of wireless communication, e.g., a wireless-enabled PDA, a cellular phone, a tablet PC, or a wireless-enabled notebook.

In one embodiment, the client device 130 may include an antenna or transceiver 138 to transmit and receive signals to and from a WAP 152. In particular, the antenna/transceiver 138 may determine existence of an accessible network 150 by scanning for nearby beacon frames broadcast by the WAP 152.

Once a beacon frame is received by the antenna/transceiver 138, the beacon frame may be forwarded to the processor 132. The processor 132 may parse the beacon frame to determine the SSID of the nearby network 150 and/or the MAC address of the WAP 152. The processor 132 may also determine the signal strength of the beacon frame. For simplicity reasons, the SSID, the MAC address, and the signal strength may be collectively referred to the scan information.

In one embodiment, the antenna/receiver 138 may detect beacon frames broadcast by more than one WAP 152. The WAPs 152 may belong to the same or different networks 150. The signal strengths of the beacon frames may vary from each other depending on the distance between the client device 130 and each WAP 152. Accordingly, the location of the client device 130 relative to the WAPs 152 may be discerned from the signal strengths.

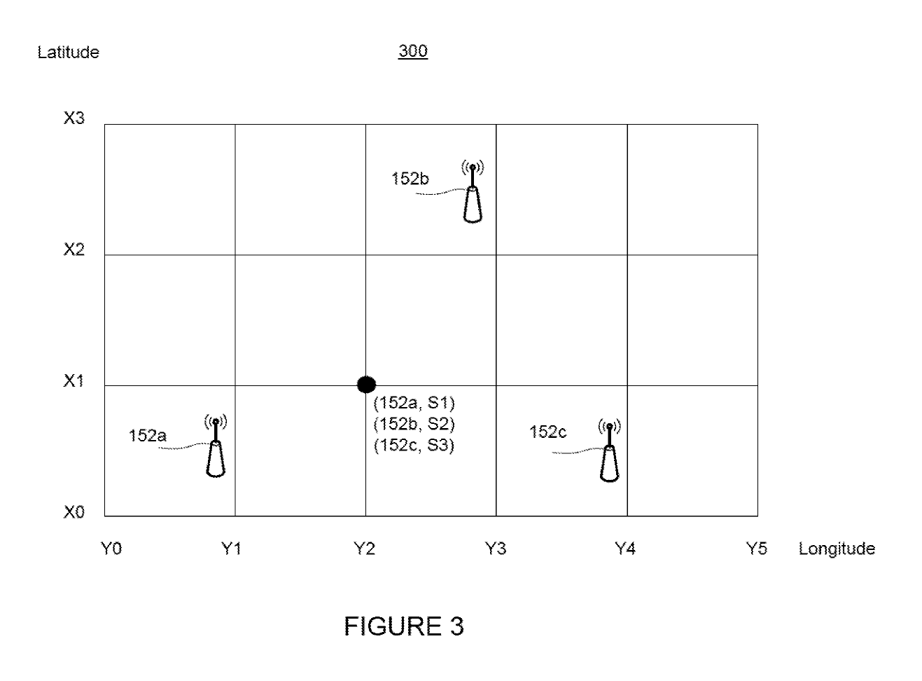

The memory 134 of the client device 130 may include a wireless access point map 300 of a region as illustrated in FIG. 3. The map 300 may be constructed on different scales, e.g., international, national, or local. Alternatively, the map 300 may represent an indoor space within a building. In one embodiment, the map 300 may include a latitude/longitude coordinate system as shown in FIG. 3. Each point on the map 300 may be associated with a pair of latitude/longitude coordinates. Each point may also be associated with scan information expected to be detected at that point. For each point, the expected scan information may include information about one WAP 152 expected to be detected at that particular point. More specifically, the expected scan information may include the MAC address of the WAP 152, the signal strength of a beacon frame broadcast by the WAP 152 expected to be detected at that particular point, and optionally, the SSID of the network 150 that the WAP 152 belongs to. In one aspect, the expected scan information may include information about more than one WAP 152.

For instance, as illustrated in FIG. 3, a point (X1, Y2) corresponds to a position at latitude X1 and longitude Y2. At (X1, Y2), the expected scan information may include 3 sets of information related to each of the WAPs 152a, 152b and 152c. More specifically, the expected scan information may include the expected signal strength S1 from the first WAP 152a, the expected signal strength S2 from the second WAP 152b, and the expected signal strength S3 from the third WAP 152c. The expected scan information may be collected by a collecting device with an antenna that visits each point on the map 300. Each point may be associated with a unique set of signal strengths.

Based on the above, after the client device 130 discerns the scan information, the client device 130 may compare its discerned scan information with the expected scan information of each point on the map 300 in order to determine the position of the client device 130 on the map.

While the map 300 is constructed based on three WAPs 152a, 152b and 152c, any number of WAPs may be used. Based on the number of WAPs, the wireless access point map 300 may include significantly more or less details.

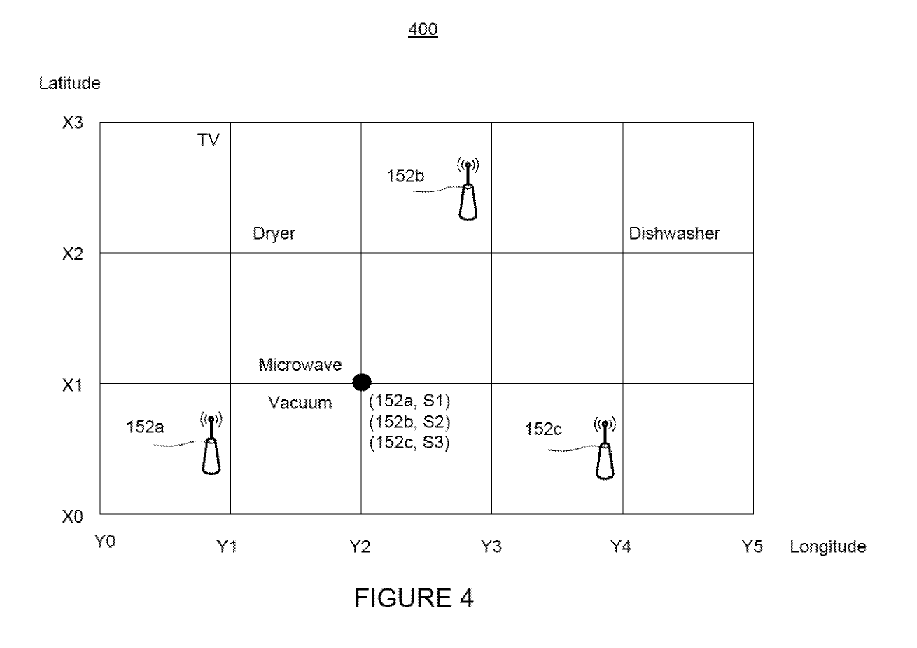

In another embodiment, as shown in FIG. 4, the map 400 represents an indoor space of a building, e.g., a retail store. Each point on the map may be associated with products within its vicinity, or within a predetermined radius, e.g. 5 feet, of the point. For instance, the point (X1, Y2) is not only associated with (152a, S1), (152, S2) and (152c, S3), but is also associated with nearby products Microwave and Vacuum. As seen in FIG. 4, since TV, Dishwasher and Dryer are placed far away from the point (X1, Y2), these products are not considered as nearby products of (X1, Y2). Accordingly, based on the scan information, the client device 130 may determine products within its proximity. The products information may suggest the user's purchase interest at the instantaneous moment.

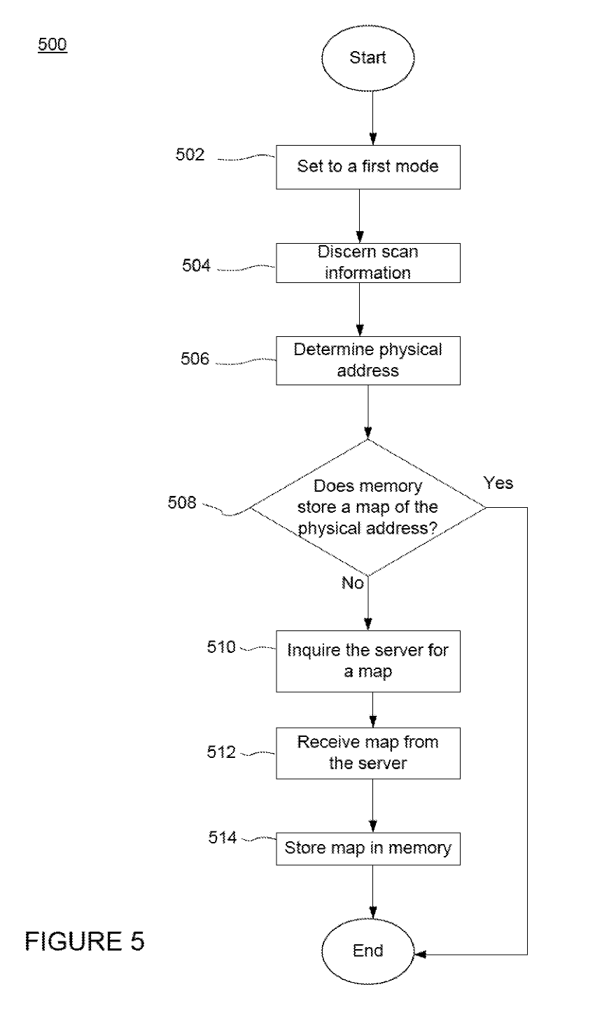

The client device 130 may be pre-packaged or pre-downloaded with maps 300 or 400 for different indoor spaces, or may need to request the maps from the server 110. FIG. 5 is a flowchart 500 illustrating a method of the client device 130 for receiving a map in accordance with one embodiment of the present disclosure.

Initially, at step 502, a user of the client device 130 may set the client device 130 to a first mode, which may enable determination of the location of the client device 130 by the client device 130 or by the server 110. By contrast, a second mode disables the client device 130 and the server 110 from determining the location of the client device 130.

A user may sign up or opt to participate (a “participant”) in order to operate the client device in the first mode as described herein. Participants may be required to take an affirmative step in order to participate. For example, participants may be required to sign in to a service before providing any information. Participants may be paid for the data provided and may also be provided with an explanation of how and why their data is being used. Similarly, participants may be provided with the opportunity to cease participation temporarily or permanently at any time.

At step 504, the client device 130 may gather or discern the scan information. At step 506, the client device 130 may determine its current physical address. Steps 504 and 506 may take place in any order, or may take place simultaneously. At step 506, the client device 130 may include a couple of alternate mechanisms to determine its current physical address as described below.

In one aspect, the client device 130 may identify the address last recorded by a GPS system as its current physical address. For instance, if the client device 130 is in an indoor space, or any space without satisfactory GPS satellite reception, then the last address detected by the GPS system as recorded on the client device 130 may be the address of the client device 130 before it enters the indoor space, which may be the physical address of the indoor space.

In another aspect, the client device 130 may determine the current physical address by prompting for manual entry of the physical address of the indoor space to be entered by the user.

In another different aspect, the client device 130 may determine its current physical address based on the scan information discerned at step 504. The client device 130 may have stored therein scan information gathered in the past or known in advance, and corresponding physical address determined in the past or known in advance. After gathering scan information at step 504, the client device 130 may look up any corresponding physical address in the stored data at step 506. At step 506, the client device 130 may also query the server 110 for its current physical address by transmitting to the server 110 the scan information discerned at step 504.

At step 508, the client device 130 may determine if a map associated with the current physical address, e.g., the address of the indoor space, is available in its memory 134. If not, at step 510, the client device 130 may inquire the server 110 for a map related to its current physical address. The client device 130 may make the inquiry by using any one of the following alternative mechanisms.

In one aspect, at step 510, the client device 130 may send to the server 110 its current physical address as determined at step 504.

In another aspect, at step 510, the client device 130 may send the scan information discerned at step 504 to the server 110. The server 110 may first determine the physical address of the client device 130 using the scan information. The server 110 may then determine the map associated with the physical address.

Thereafter, at step 512, the client device 130 may receive from the server 110 a map associated with its current physical address, e.g., a map associated with the indoor space, from the server 110. At step 514, the client device 130 may store the map in its memory 134.

The client device 130 may store the map in a versatile memory, e.g., RAM, such that the client device 130 may need to download the map 300 from the server 110 each time when the client device 130 needs the map of the same indoor space. Alternatively, the client device 130 may store the map in a non-versatile memory, e.g. ROM, to avoid future downloads from the server 110 for the same map.

The same mechanism illustrated in FIG. 5 may be used to retrieve any type of map, e.g. map 300 of FIG. 3, map 400 of FIG. 4, or other similar maps.

As described above, when a user configures the client device 130 to the first mode, the client device 130 may communicate its physical address or scan information to the server 110. In the same mode, the client device 130 may broadcast its location information periodically to the server 110, or may provide location information to the server 110 upon request, such that the server 110 may have real-time or near real-time location information of the client device 130. For instance, in the first mode, as the user moves, the client device 130 may selectively transmit any or all of the following information to the server 110 at regular time intervals or as polled or requested by the server 110: the physical address of the client device 130, the scan information, the latitude/longitude coordinates information, and/or the nearby products information.

In contrast, when the user configures the client device 130 to the second mode, the client device 130 is disabled from broadcasting information described above to the server 110.

In one embodiment, the user may have discretion to permit advertisements on the client device. For instance, the client device 130 may receive advertisement information based on the user's instantaneous interests as discerned from the position of the client device 130, e.g., the present position of the client device 130 in an indoor space, such as a retail store.

Various embodiments of the client device 130 operations with respect to receiving advertisements will now be described. It should also be understood that the following operations do not have to be performed in the precise order described below. Rather, various steps may be handled in a different order or simultaneously. Steps may also be omitted or added unless otherwise stated herein.

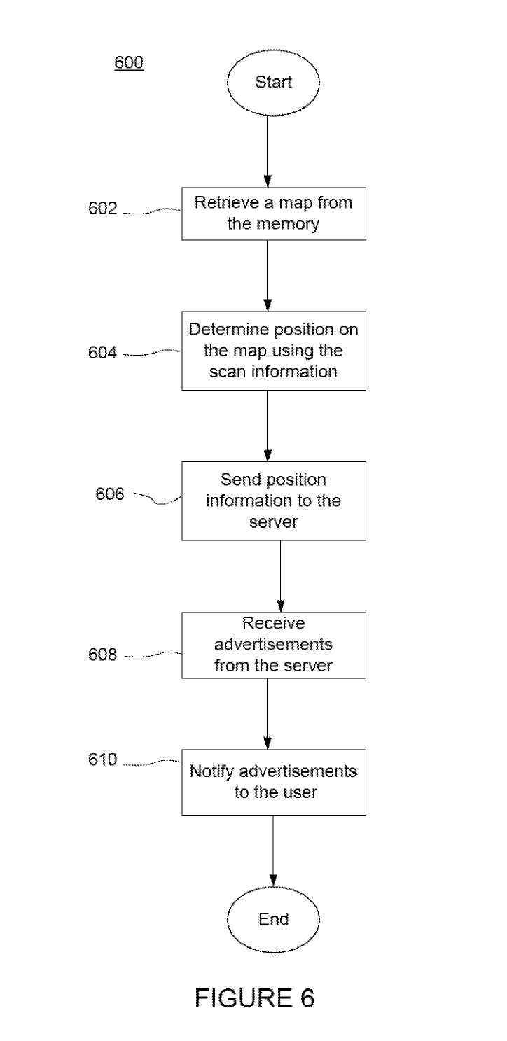

In one embodiment, the client device 130 may determine its position within the indoor space, and may receive advertisements based on its position. FIG. 6 is a flowchart 600 illustrating a method of the client device 130 regarding this aspect. In one aspect, the method illustrated in the flowchart 600 may be performed by the client device 130 subsequent to the method illustrated in the flowchart 500 of FIG. 5.

At step 602, the client device 130 may retrieve from its memory 134 a map associated with its current physical address as determined at step 504 of FIG. 5. This map has been stored in the memory 134 as described in the flowchart 500 of FIG. 5. At step 604, the client device 130 may determine its instantaneous latitude/longitude coordinates in the indoor space based on the map retrieved from step 602 and the scan information discerned at step 504 of FIG. 5. Specifically, the client device 130 may iterate through each point in the map, and may determine if the expected scan information associated with each point matches with the scan information discerned by the client device 130 at step 504. When there is a match, the position of the client device 130 may be determined. Thereafter, at step 606, the client device 130 may inform the server 110 about the determined instantaneous coordinates. The server 110 may in turn determine products that are within the user's instantaneous interests, and may return advertisements oriented to the user's instantaneous interest at step 608. Thereafter, at step 610, the client device 130 may notify the advertisements to the user.

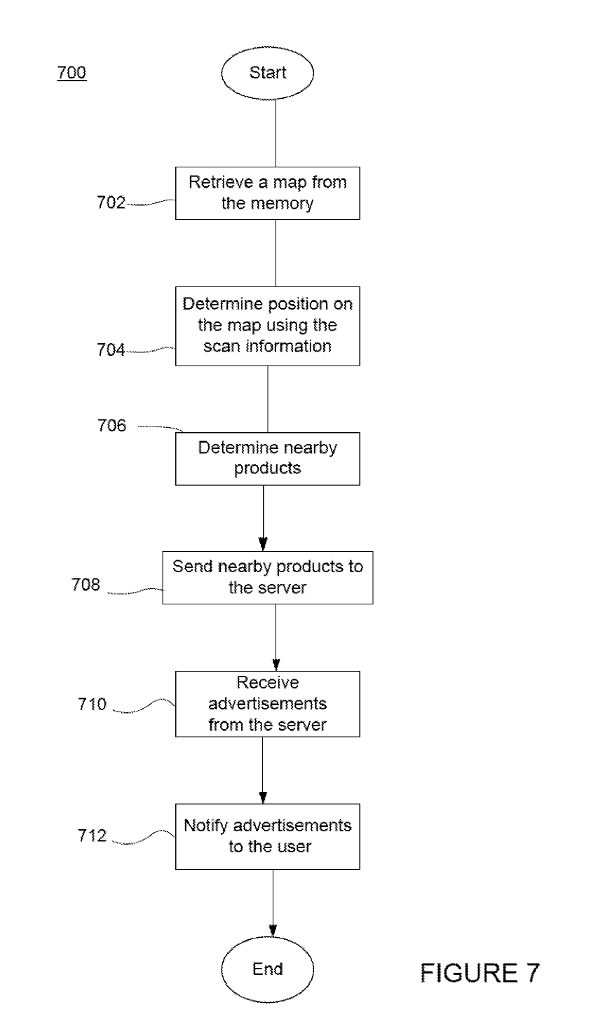

In another embodiment, the client device 130 may determine products within its vicinity and may receive advertisements from the server 110 related to those products. FIG. 7 is a flowchart 700 illustrating a method of the client device 130 regarding this aspect. Steps 702-704 may be identical or substantially similar to steps 602-604. After the client device 130 determines its instantaneous latitude/longitude coordinates in the indoor space at step 704, the client device 130 may determine nearby products at step 706, e.g., within a radius of 5 feet of the determined latitude/longitude coordinates on the map 400. The products determined at step 706 may represent the products of the user's instantaneous interests. At step 708, the client device 130 may inform the server 110 about the list of products determined at step 706. The server 110 may return advertisements related to the products of the user's instantaneous interest at step 710. Thereafter, at step 712, the client device 130 may notify the advertisements to the user.

In one embodiment, the client device 130 does not store or receive maps 300 or 400 from the server 110. In this embodiment, the client device 130 does not determine its position within an indoor space. Rather, the client device 130 may forward the physical address information of the indoor space to the server 110, and let the server 110 determine position of the client device 130 within the indoor space.

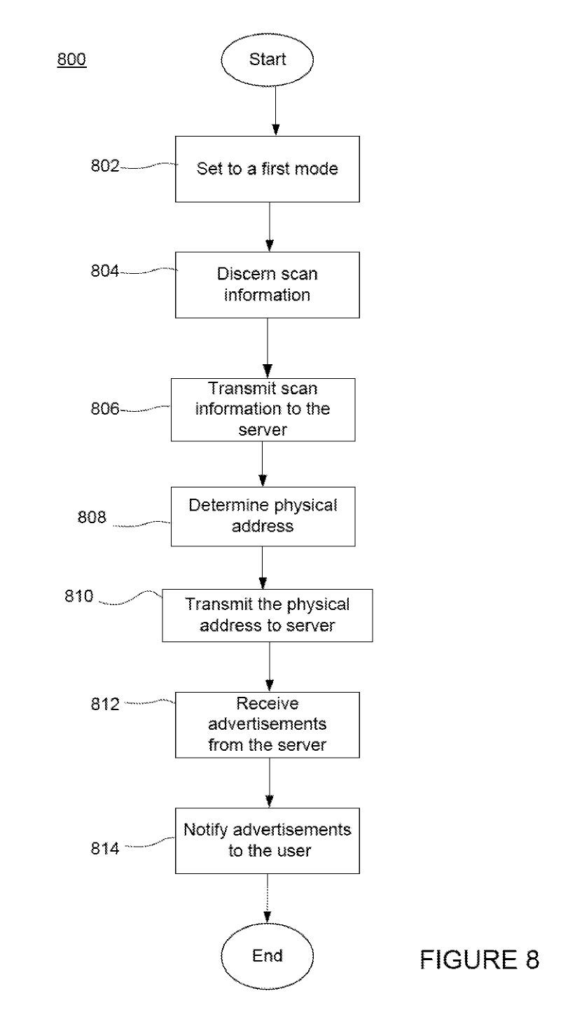

FIG. 8 is a flowchart illustrating a method of the client device 130 regarding this aspect. Initially, at step 802, the user of the client device 130 may set the client device 130 to the first mode. At step 804, the client device 130 may gather the scan information. Step 804 may be identical or substantially similar to step 504 of FIG. 5 described earlier. At step 806, the client device 130 may send the scan information to the server 110. At 808, the client device 130 may determine the current physical address, e.g., the address of the indoor space. Step 808 may be identical or substantially similar to step 506 of FIG. 5 described earlier. At step 810, the client device 130 may send the current physical address to the server 110. Steps 808-810 may take place before, during, or after steps 804-806. Steps 806 and 810, about sending the scan information and the current physical address may take place simultaneously.

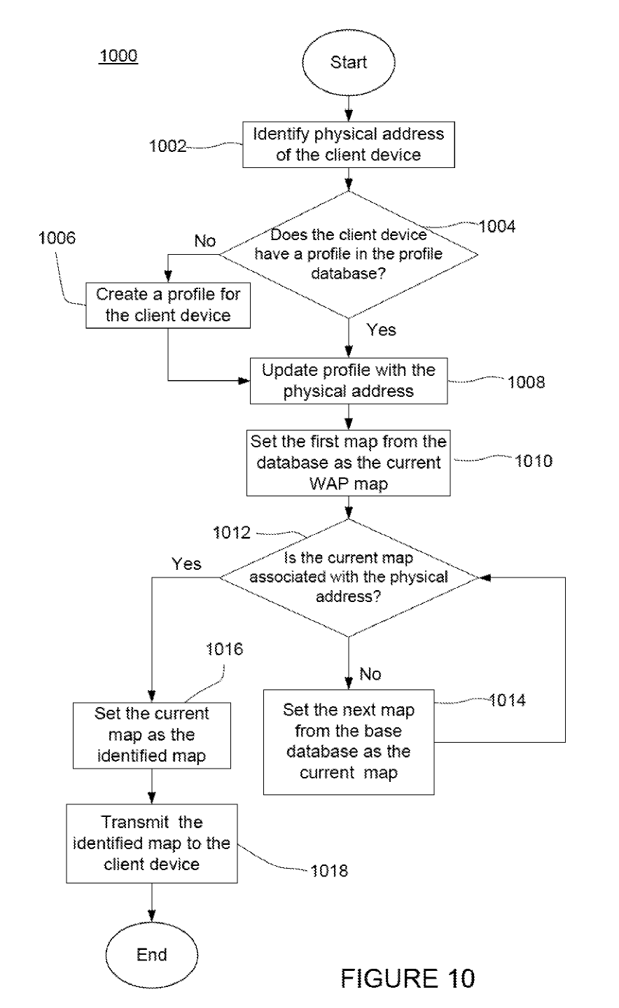

In one aspect, steps 808-810 may be omitted. The server 110 may compute the current physical address of the client device 130 based on the scan information sent by the client device 130 at step 806. Detailed operations performed by the server 110 are described later with respect to FIGS. 10-13.

At step 812, the client device 130 may receive advertisements from the server. Thereafter, at step 814, the client device 130 may notify the advertisements to the user.

In another embodiment, the client device 130 may include an advertisement application, which may be downloaded to the client device 130 at the user's discretion. The user may enable or disable receiving advertisements via configuration of the advertisement application. The user may create a user profile in the application, including login information such as a user name, and password or passphrase. The user may also configure the application to govern information exchange between the client device 130 and the server 110.

For instance, the user may configure which one or more, if any, of the following location-related information may be sent to the server 110 via the advertisement application: physical address of the indoor space, scan information, position of the client device 130 in the indoor space, and/or the nearby products. The user may also configure which user information may be sent together with the location-related information to the server 110, such as a user profile including a unique identifier of the client device 130. As a result, each transmission of the location-related information sent to the server 110 may be associated with a unique device identifier.

Advertisements may be provided to the client device 130 in any one or more of the following forms: a pop-up, a banner ad message, an advertisement screen, a sponsored map, an ad page on a mobile web browser, and the like. The advertisements may include messages in the form of text, graphics, animation, logo, trademark, or other suitable formation. Each advertisement may be displayed for only a pre-set period of time, e.g. 3 seconds.

Referring back to FIG. 2, the server 110 may include a processor 162 and a memory 164 that may define logic for processing the location-related information of the client device 110, and logic for transmitting advertisements to the client device 110 based on the location-related information. The server 110 may include or may be coupled to one or more relation databases 166, 168 and 170 that store one or more of the following data: inventory, WAP maps, and profiles. While each database is shown as a separate physical database, the databases may form one contiguous database system.

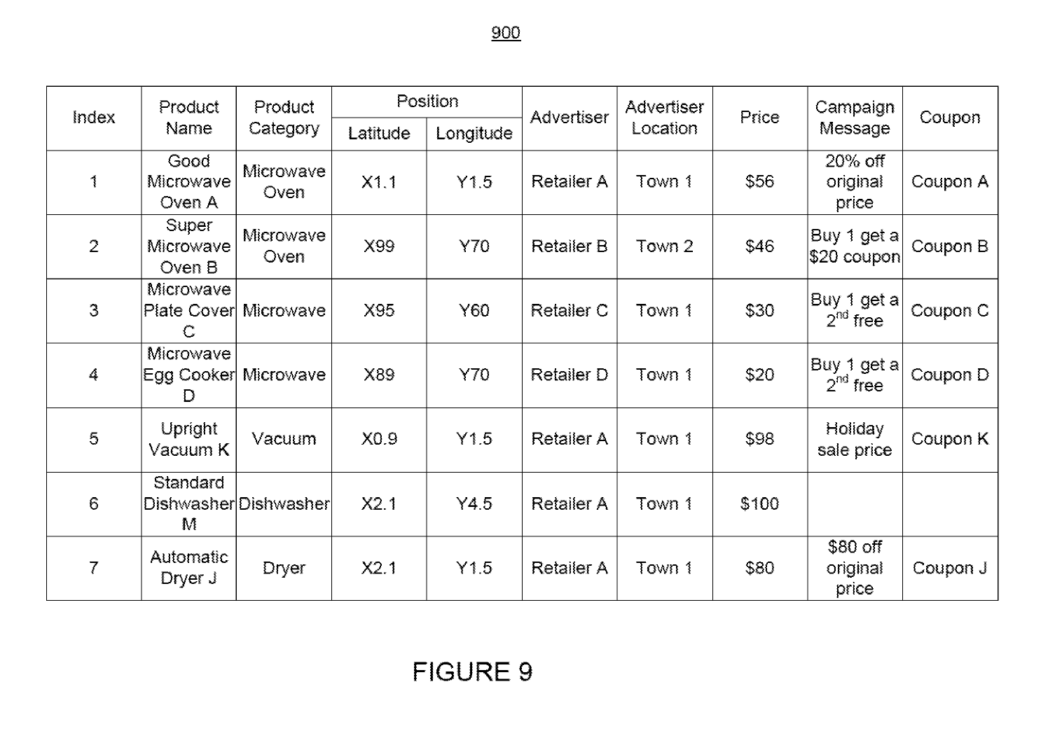

The inventory database 166, illustrated in FIG. 2, may include advertising information provided by one or more advertisers, e.g., retail stores. As illustrated in table 900 of FIG. 9, the advertising information may generally include one or more of the following information: product name, product category, position, advertiser name, price, campaign message, and/or coupon. The server 110 may include an online interface that enables advertisers, e.g., retailers, to input their advertisements. When providing advertising information to the server 110, the advertisers may specify a certain target radius of the advertising location, or geographically, such as the city, district, or state in which the advertisements will be broadcast. Using the inventory data, the server 110 may determine products available within a predetermined radius of a given position, e.g., as defined by latitude/longitude coordinates.

The WAP maps database 168 may include a list of WAP maps corresponding to different physical addresses, such as physical addresses associated with different retailers or different indoor spaces. Based on a physical address provided by the client device 130, the server 110 may identify the WAP map associated with the physical address. Thereafter, the server 110 may send the identified WAP map to the client device 130. Alternatively, without sending the identified WAP map to the client device 130, the server 110 may determine the position of the client device 130 on the identified WAP map based on the scan information sent by the client device 130.

The profile database 170 may include profiles created for each client device 130, if the client device 130 is configured by a user to allow determining the location of the client device 130 and allow receiving advertisements based on the location. Specifically, for each client device 130, its profile as stored in the profile database 170 may include one or more of the following pertinent information: client device identifier, physical address, scan information, position within an indoor space, products within the user's instantaneous interest, advertisements sent to the client device 130, and/or coupons associated with the advertisements.

The server 110 may include logic to select advertisements to be delivered to the client device 130 based on one or more of the location-related information, such as the physical address of the client device 130, the scan information, the position of the client device 130 within an indoor space, and/or products nearby the client device 130.

Various embodiments of how the server 110 processes different location-related information will now be described. The following operations do not have to be performed in the precise order described below. Rather, various steps may be handled in a different order or simultaneously. Steps may also be omitted or added unless otherwise stated herein.

FIG. 10 is a flowchart 1000 illustrating a method for identifying a map associated with the physical address of the client device 130 in accordance with one embodiment. At step 1002, the server 110 may identify a current physical address associated with the client device 130.

In one aspect, the physical address may be the physical address transmitted by the client device 130. In another aspect, the server 110 may have stored therein scan information gathered in the past or known in advance, and corresponding physical address determined in the past or known in advance. The server 110 may look up the physical address based on the scan information provided by the client device 130.

In a further aspect, the server 110 may compute the physical address based on the scan information transmitted by the client device 130. After computation, the server 110 may store the computed physical address together with its corresponding scan information for its records.

At step 1004, the server 110 may determine if a profile has been created in the profile database 170 for the client device 130. If not, the server 110 may create a profile for the client device 130 at step 1006, and then may proceed to step 1008. At step 1008, the server 110 may update the profile of the client device 130 with the physical address. Steps 1004-1008 may be optional and may be ignored when the profile database 170 does not exist.

In the following steps, the server 110 may iterate through the map entries in the WAP map database 168 to identify a map associated with the physical address identified at step 1002. For instance, at step 1010, the server 110 may select the first map entry in the database to be the current map. At step 1012, the server 110 may determine if the physical address associated with the current map as stored in the database matches with the physical address of the client device 130. At step 1014, if there is no match, the server 110 may select the next map entry in the database as the current map, and may then repeat step 1012. If a match is found, at step 1016, the current map may be set as the identified map. At step 1018, the server 110 may transmit the identified map to the client device 130. By using the identified map, the client device 130 may identify its position on the map based on the scan information gathered by the client device 130. Alternatively, if the client device 130 is not configured to receive the map from the server 110, the server 110 may ignore step 1018 and may determine position of the client device 130 in the identified map as described below.

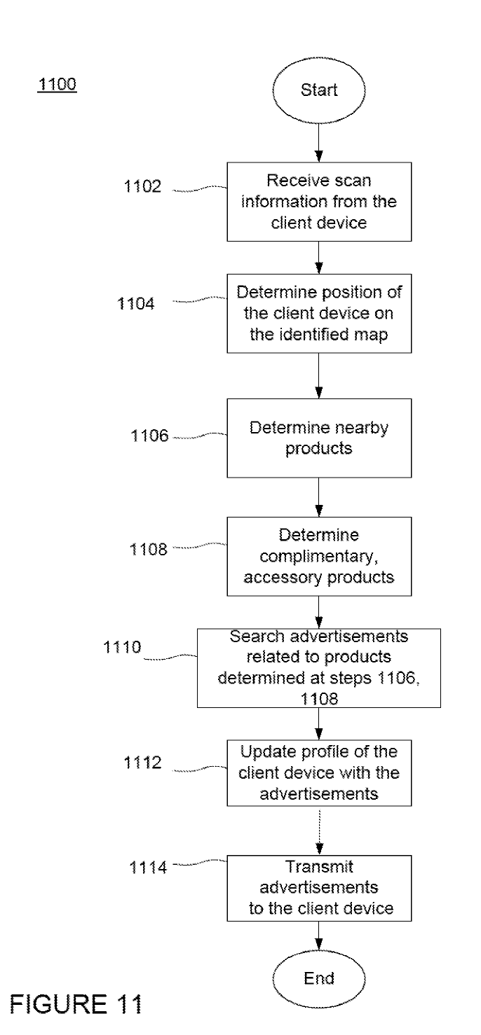

FIG. 11 is a flowchart 1100 illustrating a method for providing advertisements to the client device 130 based on the scan information. At step 1102, the server 110 may receive the scan information from the client device 130. At step 1104, the server 110 may determine the position of the client device 130 on the map identified at step 1016. For instance, the server 110 may determine the latitude and longitude coordinates of the client device 130. At step 1106, the server 110 may determine products within the vicinity of the client device 130.

Different mechanisms may be used to identify nearby products. For instance, the map identified by the server 110 at step 1016 may be the map 400 (FIG. 4), and the server 110 may determine products placed close to the client device 130 on the map 400. Alternatively, the server 110 may search the inventory database 166 for any product positioned within a close radius of the client device 130, e.g., within a 3-foot radius of the latitude/longitude coordinates of the client device 130. As an optional step at 1108, the server 110 may determine other products or services relevant to the nearby products identified at step 1106. Relevant products or services include products or services that are complementary to or accessories of the nearby products. For example, if TV is one of the nearby products determined at step 1106, then its relevant products may include a TV cable, a 4-year warranty service, and/or a 2-year contract with a cable provider. At step 1110, the server 110 may search the inventory database 166 for advertisements of the nearby products identified at step 1106 and advertisements of relevant products identified at step 1108. The search may be restricted to advertisements offered within a certain radius of the client device 130, e.g., 2 miles, or offered within a certain geography identified by town, state, postal code or other zone constraints. The zone constraint may be identified by the user in the user profile of the client device 130, which may be forwarded to the server 110 during transmission. Alternatively, the server 110 may maintain a default zone constraint for any search or any advertisement, and the zone constraint may be configured by an advertiser or a retailer.

The search may be restricted to products offered by other locations, e.g., retail stores, and advertised at a lower price than that offered at the current retail store where the client device 130 is. For instance, if the client device 130 is currently at Retailer A, the advertisements determined at step 1110 may be advertisements offered by other retailers within a search zone, excluding Retailer A. At step 1112, the server 110 may update the profile of the client device 130 with the advertisements determined at step 1110. Thereafter, at step 1114, the server 110 may transmit the advertisements to the client device 130.

The server 110 may receive the scan information at a regular time interval, e.g., every 5 minutes. As a result, the server 110 may perform steps 1102-1114 periodically on a regular basis, e.g., every 5 minutes.

In some instances, the server 110 may transmit coupons and/or gift cards along with the advertisements to the client device 130. Each coupon sent to the client device 130 may be associated with a unique device identifier. Coupons may include a coupon code, barcode, or other mechanisms to validate the coupon to the advertiser or retailer.

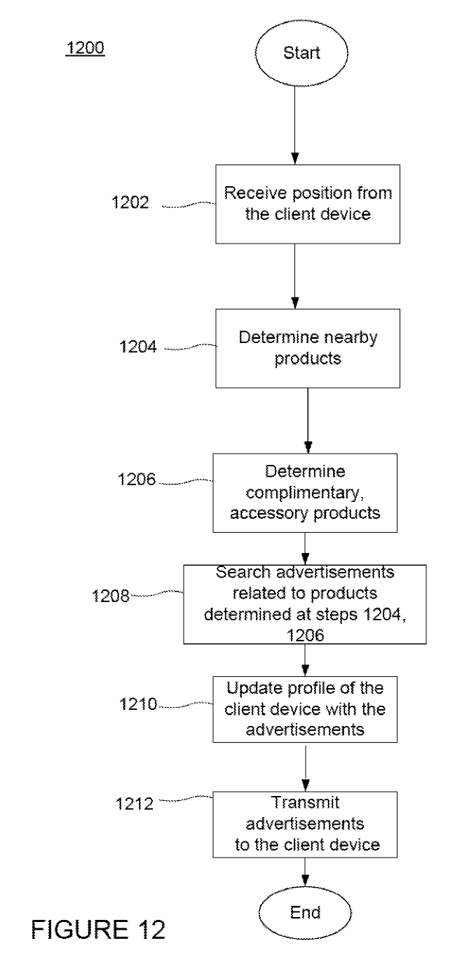

In one embodiment, if the client device 130 is configured to identify its position on a map and pass that information to the server 110 as illustrated in steps 604-606 of FIG. 6, the server 110 may return advertisements to the client device 130 based on the position of the client device 130 as illustrated in a flow diagram 1200 of FIG. 12. Here, at step 1202, the server 110 may receive the position of the client device 130, e.g., defined in latitude/longitude coordinates. The server 110 may then perform steps 1204-1212, which may be identical or substantially similar to the steps 1106-1114 discussed above regarding FIG. 11.

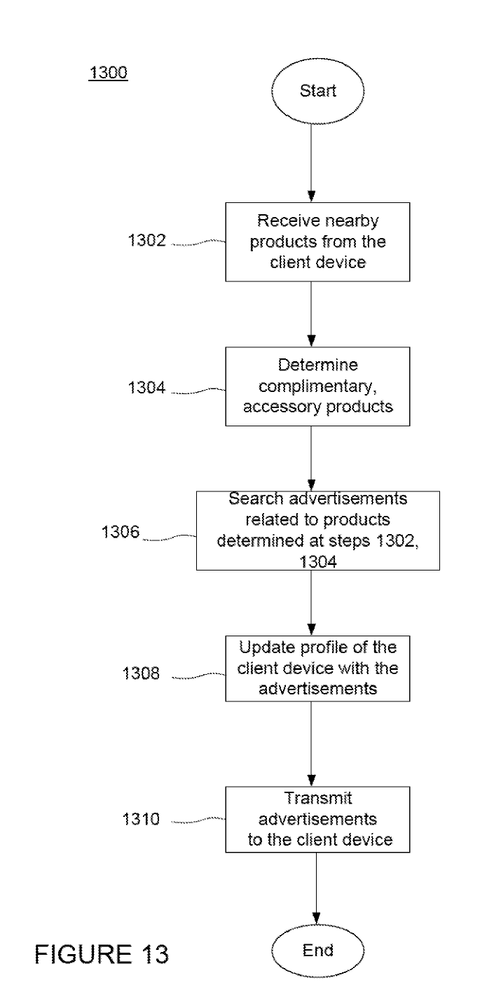

In another embodiment, if the client device 130 is configured to determine its nearby products information and pass that information to the server 110 as illustrated in steps 706-708 of FIG. 7, the server 110 may execute a method according to the flow diagram 1300 of FIG. 13. At step 1302, the server 110 may receive the nearby products information from the client device 130. The server 110 may then perform steps 1304-1310, which may be identical or substantially similar to the steps 1108-1114 of FIG. 11.

Once advertisements have been delivered to the client device 130, the server 110 may determine whether one or more advertisements have been clicked by the user. The server 110 may also determine if any coupon code associated with the advertisements is used. For instance, the server 110 may receive reports from advertisers or retailers when the coupon code is redeemed.

The server 110 may implement different revenue models to get paid in exchange for distributing advertisements and coupons. The advertisers may be charged according to any one of the following mechanism, e.g., a subscription basis, a pre-ad basis, or a transmission basis to the users. Alternatively, the advertisers may be charged per user click on the advertisement displayed on the client device 130. Further, the advertisers may be charged when the user redeems a coupon. In another example, an advertiser may be charged if the user goes to a retail store as suggested by an advertisement within a predetermined period of time from the time the client device 130 displays the advertisement. In one aspect, more than one advertiser or retailer may share the cost of advertising and the sale proceed, when the advertisers or retailers advertise the same product.

A specific example of how the system 100 may be used in practice is described next. The use of the system 100 may not be restricted to the specific example. Other uses similar to or different from that described below may be envisioned.

First, a user with a client device 130 enters a store named Retailer A, and stands in an aisle displaying microwaves. After the user activates the first mode on the client device 130 to allow determination of the location of the client device 130, the client device 130 receives a map 300 of Retailer A, as illustrated in FIG. 3, from the server 110, and then determines that it is at point (X1, Y2) based on its scan information. Thereafter, the client device 130 informs the server 110 about its (X1, Y2) position. The server 110 looks up the inventory of FIG. 9 for any products positioned close to (X1, Y2) to determine the user's instantaneous interests, and identifies products close to (X1, Y2), e.g., Good Microwave Oven A at (X1.1, Y1.5) and Upright Vacuum K at (X0.9, Y1.5). The server 110 then looks up the inventory of FIG. 9 for advertisements related to microwaves and vacuums, including their accessories or complementary, offered at other stores within the same town of Retailer A, and finds the following products: Microwave Plate Cover C and Microwave Egg Cooker D. The server 110 then forwards the advertisements of the above products to the client device 130. Because Super Microwave Oven B is offered in a different town, it is not forwarded to the client device 130.

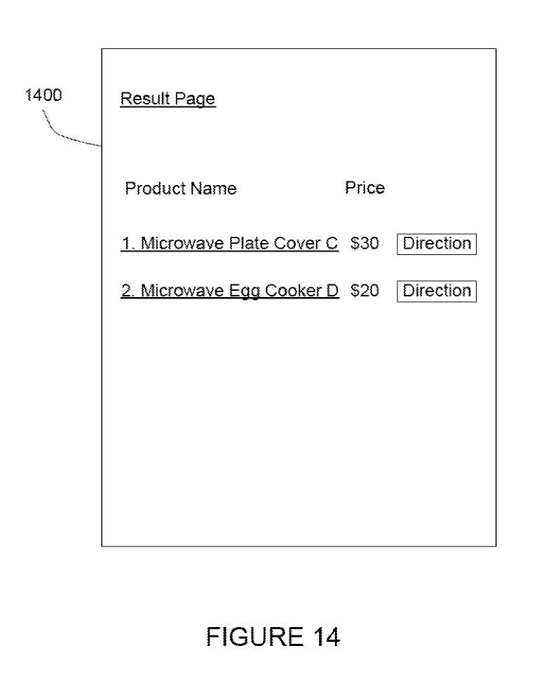

FIG. 14 is an illustration of a Graphical User Interface screen 1400 of the client device 130 that illustrates the advertisements information transmitted from the server 110. The user may click on each advertisement for more information, and may also click on the “Direction” button to find out the direction to the advertiser. Each advertisement may include a redeemable coupon with a bar code. When the user redeems the coupon at the advertiser, the server 110 may charge the advertiser an advertising fee.

The algorithms or processes described above as performed by the server 110 or the client device 130 may be implemented in software, hardware, firmware, or any combination thereof. The algorithms or processes may be implemented in one or more computer programs executing on a programmable computer including a processor and a storage medium readable by the processor. Each computer program may be implemented in any programming language including, e.g., an assembly language, a machine language, a high-level procedural programming language, or an object-oriented programming language. The programming language may, e.g., be a compiled or interpreted programming language.

As these and other variations and combinations of the features discussed above can be utilized without departing from the subject matter defined by the claims, the foregoing description of exemplary embodiments should be taken by way of illustration rather than by way of limitation of the subject matter defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method for providing an advertisement on a wireless device, the method comprising:
receiving a message broadcast by a wireless access point;
determining a signal strength of the received message;
identifying, with a processor, a wireless access point map associated with an indoor space, the map defining a plurality of positions, at least one position defined on the map being associated with a plurality of signal strengths of messages broadcast by different wireless access points, at least one position defined on the map being associated with a product;
identifying a position of the wireless device on the map using the determined signal strength;
identifying, using the map, a product placed within a predetermined distance of the identified position;
sending information about the product to a server;
receiving an advertisement related to the product from the server; and
providing the advertisement for presentation on the wireless device.

2. The method of claim 1, wherein the map includes a latitude/longitude coordinate system.

3. The method of claim 1, further comprising determining a physical address of the indoor space based on the determined signal strength, and identifying the map based on the physical address.

4. The method of claim 3, further comprising receiving the map associated with the physical address from the server.

5. The method of claim 1, wherein the advertisement relates to another product, the another product being related to the product placed within the predetermined distance of the identified position, the another product being offered at a physical address different from that of the indoor space.

6. An apparatus for providing an advertisement, the apparatus comprising:
a receiver configured to receive a message broadcast by a wireless access point;
a memory; and
a processor in communication with the memory, the processor configured to:
determine a signal strength of the message received by the receiver;
identify a wireless access point map associated with an indoor space, the map defining a plurality of positions, at least one position defined on the map being associated with a plurality of signal strengths of messages broadcast by different wireless access points, at least one position defined on the map being associated with a product;
identify a position of the apparatus on the map using the determined signal strength;
identify, using the map, a product placed within a predetermined distance of the identified position;
send information about the product to a server;
receive an advertisement related to the product from the server; and
present the advertisement.

7. The apparatus of claim 6, wherein the receiver includes at least one of an antenna and a transceiver.

8. The apparatus of claim 6, wherein the map includes a latitude/longitude coordinate system.

9. The apparatus of claim 6, wherein the processor is further configured to determine a physical address of the indoor space based on the determined signal strength, and identify the map based on the physical address.

10. The apparatus of claim 9, wherein the processor is further configured to receive the map associated with the physical address from the server.

11. The apparatus of claim 6, wherein the advertisement relates to another product, the another product being related to the product placed within the predetermined distance of the identified position, the another product being offered at a physical address different from that of the indoor space.

12. A method for providing an advertisement, the method comprising:
receiving a signal strength of a message broadcast by a wireless access point as determined by a wireless device;
identifying, with a processor, a wireless access point map associated with an indoor space, the map including a plurality of positions, at least one position defined on the map being associated with a plurality of signal strengths of messages broadcast by different wireless access points, at least one position defined on the map being associated with a product;
identifying a position of the wireless device on the map based on the received signal strength;
identifying, using the map, a product positioned within a predetermined distance of the identified position of the wireless device; and
transmitting an advertisement related to the product to the wireless device.

13. The method of claim 12, further comprising identifying another product related to the determined product, and transmitting an advertisement related to the another product to the wireless device.

14. The method of claim 13, wherein the another product is offered at a physical address different from that of the indoor space.

15. The method of claim 12, further comprising storing at least two wireless access point maps each corresponding to a different indoor space.

16. The method of claim 12, further comprising determining a physical address of the indoor space based on the determined signal strength, and identifying the map based on the physical address.

17. A system for providing an advertisement, the system comprising:
a memory; and
a processor in communication with the memory, the processor configured to:
receive, from a wireless device, a signal strength of a message broadcast by a wireless access point as determined by the wireless device;
identify a wireless access point map associated with an indoor space, the map including a plurality of positions, at least one position defined on the map being associated with a plurality of signal strengths of messages broadcast by different wireless access points, at least one position defined on the map being associated with a product;
identify a position of the wireless device on the map based on the received signal strength;
identify, using the map, a product positioned within a predetermined distance of the identified position of the wireless device; and
transmit an advertisement related to the product to the wireless device.
